(19) United States
(12) Patent Application Publication
(10) Pub. No.: US 2026/0140520 A1
(43) Pub. Date: May 21, 2026

(54) Modelling and H-infinity Control Method of a Two-phase Annular Flow System for Oil and Gas Transportation

(71) Applicant: Beijing Institute of Technology, Beijing (CN)

(72) Inventors: Qi Wang, Beijing (CN); Wen Kang, Beijing (CN)

(21) Appl. No.: 19/055,544

(22) Filed: Feb. 18, 2025

(30) Foreign Application Priority Data
Nov. 15, 2024 (CN) 202411630611.4

(51) Int. Cl. G05D 7/06; G05B 13/04

(52) U.S. Cl. CPC G05D 7/0617; G05B 13/04

(57) ABSTRACT

The present invention provides a modelling and H_{∞} control method for two-phase annular flow in an oil and gas transport system. The method includes: establishing a model of two-phase annular flow based on the two-dimensional Kuramoto-Sivashinsky equation; projecting the system onto the eigenspace of the two-dimensional Sturm-Liouville operator using modal decomposition; establishing the closed-loop system and deriving the sufficient condition for internal exponential stability and the satisfaction of given performance criteria using the direct Lyapunov method, thereby solving the H_{∞} control problem for the Kuramoto-Sivashinsky system. The advantages of this invention include: simpler implementation for practical engineering, less implementation devices, and effective suppression and robustness against external disturbances.

### CROSS REFERENCE TO RELATED APPLICATIONS

The present application claims the benefit of Chinese Patent Application No. 202411630611.4 filed on Nov. 15, 2024, the contents of which are incorporated herein by reference in their entirety.

### FIELD OF THE INVENTION

The present invention relates to the field of distributed parameter system control technology, and more specifically, to H-infinity (H_{∞}) control of high-dimensional distributed parameter system based on modal decomposition method.

### BACKGROUND OF THE INVENTION

In the petroleum industry, two-phase annular flow in vertical pipes frequently occurs during oil and gas transportation. Especially in high-production natural flowing wells, when oil and gas are produced through the annulus of the casing, annular flow is often formed. To predict the liquid film descending process in vertical pipes, the Kuramoto-Sivashinsky equation model can be employed. This model captures the nonlinear effects and the instability of the liquid film flow during the descending process, thereby providing a more accurate description of the process. By designing a controller, the height of the liquid descending process can be stabilized, which is significant for practical production.

In the process of oil and gas transmission, there are uncertain disturbances, such as pipeline jitter, etc. These disturbances will affect the stability of the system, making the corresponding controller design more complex. H_{∞} control method, due to its good robustness and stability, has high stability margins and can meet the demands of practical engineering. It has been widely applied in some scenes such as the vibration suppression of flexible spacecrafts and satellite systems. Furthermore, as the spatial dimension of distributed parameter systems increases, the controller design becomes more complicated. For the high-dimensional Kuramoto-Sivashinsky equation, the spatial decomposition method can be employed to design controllers for system stabilization. However, this method may require the installation of numerous sensors and actuators, and the devices need to cover nearly the entire spatial domain. In contrast, modal decomposition is a novel method to project the state of the infinite-dimensional system onto a finite-dimensional subspace, and then design control strategies for the reduced-order model to stabilize the system. Compared with the spatial decomposition method, the modal decomposition method avoids the use of numerous devices, improving execution efficiency and preventing unnecessary resource waste. Therefore, H_{∞} control method based on modal decomposition is significant for practical engineering problems.

In summary, controllers designed by the modal decomposition method are finite-dimensional, which is easy to implement in practical engineering, and can avoid unnecessary resource waste. H_{∞} control method can effectively address external disturbances and enhances the robustness of the system. Thus, it is highly necessary to use the modal decomposition method and H_{∞} control to stabilize the high-dimensional distributed parameter systems.

### SUMMARY OF THE INVENTION

The present invention relates to the establishment of two-phase annular flow system model and H_{∞} control method for two-phase annular flow based on modal decomposition, aimed at addressing system modeling and stabilization issues in two-phase annular flow system in practical engineering applications. The ultimate goal of the present invention is to ensure the internal stability of the closed-loop system under an external disturbance and to satisfy the given performance index J<0 for a given parameter γ. Here

$$J = {\int }_{0}^{∞} {\int }_{Ω} ( {z}^{2} - {γ}^{2} {ω}^{2} ) dxdt .$$

Based on the present invention it is possible to stabilise the height of the falling liquid film of the two-phase annular flow in the pipeline to ensure the smooth operation of the oil and gas transport process.

### BRIEF DESCRIPTION OF THE DRAWINGS

FIG. 1 is a block diagram of the H_{∞} control method based on the modal decomposition of the two-dimensional Kuramoto-Sivashinsky equation.

FIG. 2 is the closed-loop system state z(x₁, x₂, t) at time t=0 with the parameters M=N₀=1, κ=−20, σ=1, K₀=74.575 and without disturbances.

FIG. 3 is the closed-loop system state z(x₁, x₂, t) at time t=10 with the parameters M=N₀=1, κ=−20, σ=1, K₀=74.575 and without disturbances.

FIG. 4 is the closed-loop system state z(x₁, x₂, t) at time t=100 with the parameters M=N₀=1, κ=−20, 0=1, K₀=74.575 and without disturbances.

FIG. 5 is the performance index J with the parameter γ=10.

### DETAILED DESCRIPTION OF THE INVENTION

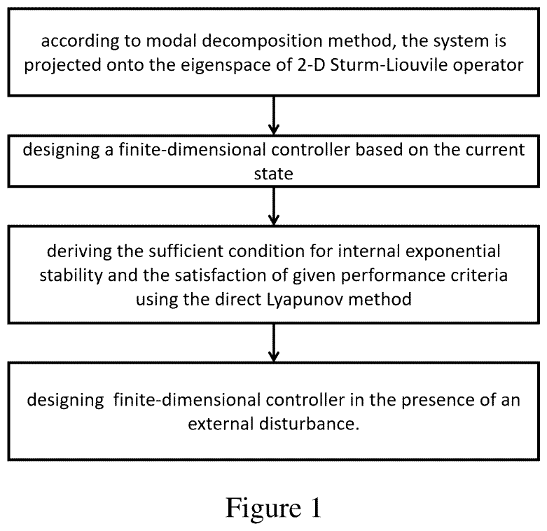

To make the objectives, technical solutions, and advantages of the present invention clearer, the detailed description of the invention will be provided with reference to specific embodiments and the accompanying drawings. According to FIG. 1, the present invention is divided into the following steps:

### 1: Establishing a Model of Two-Phase Annular Flow Based on the Two-Dimensional Kuramoto-Sivashinsky Equation;

Consider the two-dimensional Kuramoto-Sivashinsky equation on region Ω=[0,1]×[0,1]:

$$\{ \begin{matrix}{z}_{t} + {zz}_{{x}_{1}} + ( 1 - κ ) {z}_{{x}_{1} {x}_{1}} - κ {z}_{{x}_{2} {x}_{2}} + {Δ}^{2} z = b ( x ) u ( t ) , \\ z {\vert}_{\partial Ω} = 0 , \\ \frac{\partial z}{\partial n} {\vert}_{\partial Ω} = 0.\end{matrix} \qquad ( 1 )$$

Where position variable x=(x₁, x₂)∈Ω, time t>0, κ is the angle of substrate with respect to the horizontal, z∈ [symbol] denotes the thin film thickness, u(t)=col[u₁(t), . . . , u_{M}(t)] is the control input, which can control the thickness of the liquid film by adjusting the air flow rate in the tube, b(x)=[b₁(x), . . . , b_{M}(x)]∈ [symbol] ^{1×M} represents the characteristic functions such that

$${b}_{i} ( x ) = \{ \begin{matrix}1 , & x ∈ Ω , \\ 0 , & x ∉ Ω .\end{matrix}$$

2: Designing a Finite-Dimensional Controller without the Disturbance;

According to the modal decomposition method, the system can be projected onto the eigenspace of the two-dimensional Sturm-Liouvile operator.

### Consider the Two-Dimensional Sturm-Liouvile Problem

$$( \frac{{\partial }^{2}}{\partial {x}_{1}^{2}} + \frac{{\partial }^{2}}{\partial {x}_{2}^{2}} ) ϕ + λϕ = 0.$$

The boundary condition is φ|_{∂Ω}=0. Denote λₘ=m²π², λₙ=n²π², Then the corresponding eigenvalues and eigenfunctions for the Sturm-Liouvile problem are

$${λ}_{m} + {λ}_{n} = ( {m}^{2} + {n}^{2} ) {π}^{2} , {ϕ}_{mn} ( x ) = 2 sin ( \sqrt{{λ}_{m}} {x}_{1} ) sin ( \sqrt{{λ}_{n}} {x}_{2} ) , m , n = 1 , 2 ... ,$$

and the eigenfunctions form a complete orthonormal system in L²(Ω).

Then the solution of the two-dimensional Kuramoto-Sivashinsky equation can be expressed as

$$z ( x , t ) = {\sum }_{m , n = 1}^{∞} {z}_{mn} ( t ) {ϕ}_{mn} ( x ) , where {z}_{mn} ( t ) = 〈 z ( \cdot , t ) , {ϕ}_{mn} 〉 .$$

Differentiating under the integral sign, integrating by parts and using (1), we have

$${\dot{z}}_{mn} ( t ) = [ - {( {λ}_{m} + {λ}_{n} )}^{2} - κ ( {λ}_{m} + {λ}_{n} ) + {λ}_{m} ] {z}_{mn} ( t ) + {b}_{mn} u ( t ) - {g}_{mn} ( t ) ,$$

$$where$$

$${z}_{mn} ( 0 ) = 〈 z ( \cdot , 0 ) , {ϕ}_{mn} 〉 , {b}_{mn} = [ 〈 {b}_{1} , {ϕ}_{mn} 〉 , ⋯ , 〈 {b}_{M} , {ϕ}_{mn} 〉 ] , {g}_{mn} ( t ) = 〈 {zz}_{{x}_{1}} , {ϕ}_{mn} 〉 .$$

Let δ>0 be the desired decay rate. Since

$${lim}_{m \to ∞} {λ}_{m} = ∞ , {lim}_{n \to ∞} {λ}_{n} = ∞ , there exists {N}_{0} ∈ ℕ such that - {( {λ}_{m} + {λ}_{n} )}^{2} - κ ( {λ}_{m} + {λ}_{n} ) + {λ}_{m} < - δ , m , n > {N}_{0} , where {N}_{0}^{2}$$

is the controller dimension.

### Define

$${A}_{0} = diag {\{ - {( {λ}_{m} + {λ}_{n} )}^{2} - κ ( {λ}_{m} + {λ}_{n} ) + {λ}_{m} \}}_{m , n = 1}^{{N}_{0}} , \qquad {B}_{0} = {[ {b}_{11} , {b}_{12} … , {b}_{1 {N}_{0}} , {b}_{21} , ⋯ , {b}_{{N}_{0} {N}_{0}} ]}^{T} .$$

Then we design an

$${N}_{0}^{2} - dimensional$$

controller of the following form:

$$u ( t ) = - {K}_{0} {z}^{{N}_{0}^{2}} ( t ) , {z}^{{N}_{0}^{2}} = {[ {z}_{11} , … , {z}_{{N}_{0} {N}_{0}} ]}^{T} ,$$

where K₀ is the controller gain.

### 3: Deriving the Sufficient Conditions for the Regional Stability of the Closed-Loop System Via the Direct Lyapunov Method;

### Define

$${g}^{{N}_{0}^{2}} ( t ) = col \{ {g}_{11} ( t ) , … , {g}_{{N}_{0} {N}_{0}} ( t ) \} .$$

The closed-loop system can be presented as

$${\dot{z}}^{{N}_{0}^{2}} ( t ) = ( {A}_{0} - {B}_{0} {K}_{0} ) {z}^{{N}_{0}^{2}} ( t ) - {g}^{{N}_{0}^{2}} ( t ) , {z}_{mn} ( t ) = [ - {( {λ}_{m} + {λ}_{n} )}^{2} - κ ( {λ}_{m} + {λ}_{n} ) + {λ}_{m} ] {z}_{mn} ( t ) - {b}_{mn} {K}_{0} {z}^{{N}_{0}^{2}} ( t ) - {g}_{mn} ( t ) , m , n > {N}_{0} . \qquad ( 2 )$$

Consider the following Lyapunov function:

$$V ( t ) = {\vert {z}^{{N}_{0}^{2}} ( t ) \vert}_{P}^{2} + {\sum }_{m , n = {N}_{0} + 1}^{∞} ( {λ}_{m} + {λ}_{n} ) {z}_{mn}^{2} ( t ) where 0 < P ∈ {ℝ}^{{N}_{0}^{2} \times {N}_{0}^{2}} .$$

Then differentiating V(t) along the closed-loop system leads to

$$\dot{V} ( t ) + 2 δ V ( t ) = {( {z}^{{N}_{0}^{2}} ( t ) )}^{T} [ P ( {A}_{0} - {B}_{0} {K}_{0} ) + {( {A}_{0} - {B}_{0} {K}_{0} )}^{T} P + 2 δ P ] {z}^{{N}_{0}^{2}} ( t ) - 2 {( {z}^{{N}_{0}^{2}} ( t ) )}^{T} {Pg}^{{N}_{0}^{2}} ( t ) + 2 {\sum }_{m , n = {N}_{0} + 1}^{∞} [ - {( {λ}_{m} + {λ}_{n} )}^{3} - {κ ( {λ}_{m} + {λ}_{n} )}^{2} + ( {λ}_{m} + δ ) + ( {λ}_{m} + {λ}_{n} ) ] {z}_{mn}^{2} ( t ) - 2 {\sum }_{m , n = {N}_{0} + 1}^{∞} ( {λ}_{m} + {λ}_{n} ) {z}_{mn} ( t ) {g}_{mn} ( t ) - 2 {\sum }_{m , n = {N}_{0} + 1}^{∞} ( {λ}_{m} + {λ}_{n} ) {z}_{mn} ( t ) {b}_{mn} {K}_{0} {z}^{{N}_{0}^{2}} ( t ) .$$

By Young's inequality, there exists α>0 such that

$${\sum }_{m , n = {N}_{0} + 1}^{∞} - 2 ( {λ}_{m} + {λ}_{n} ) {z}_{mn} ( t ) {b}_{mn} {K}_{0} {z}^{{N}_{0}^{2}} ( t ) \leq α {\sum }_{m , n = {N}_{0} + 1}^{∞} {( {λ}_{m} + {λ}_{n} )}^{2} {z}_{mn}^{2} ( t ) + \frac{1}{α} [ {\sum }_{m , n = {N}_{0} + 1}^{∞} {\vert {b}_{mn} {K}_{0} {z}^{{N}_{0}^{2}} ( t ) \vert}^{2} ] \leq α {\sum }_{m , n = {N}_{0} + 1}^{∞} {( {λ}_{m} + {λ}_{n} )}^{2} {z}_{mn}^{2} ( t ) + \frac{1}{α} {( {K}_{0} {z}^{{N}_{0}^{2}} ( t ) )}^{T} [ {\sum }_{m , n = {N}_{0} + 1}^{∞} {b}_{mn}^{T} {b}_{mn} ] {K}_{0} {z}^{{N}_{0}^{2}} ( t ) = {\sum }_{m , n = {N}_{0} + 1}^{∞} {( {λ}_{m} + {λ}_{n} )}^{2} {z}_{mn}^{2} ( t ) + \frac{1}{α} {‖ b ‖}_{{N}_{0}^{2}} {\vert {K}_{0} {z}^{{N}_{0}^{2}} ( t ) \vert}^{2}$$

$$where$$

$${‖ b ‖}_{{N}_{0}^{2}} = [ {\sum }_{i = 1}^{m} {‖ {b}_{i} ‖}_{{N}_{0}^{2}} ] , {\sum }_{i = 1}^{M} {‖ {b}_{i} ‖}_{{N}_{0}^{2}} = {\sum }_{m , n = {N}_{0} + 1 i = 1}^{∞} {\sum }_{i = 1}^{M} {b}_{mn , i}^{2} .$$

$$Let σ > 0 , assume that {‖ {z}_{{x}_{1}} ( \cdot , t ) ‖}_{{L}^{2} ( Ω )}^{2} + {‖ {z}_{{x}_{2}} ( \cdot , t ) ‖}_{{L}^{2} ( Ω )}^{2} \leq 2 {σ}^{2} , ∀ t > 0.$$

By Young's inequality, one has

$$- 2 {\sum }_{m , n = {N}_{0} + 1}^{∞} ( {λ}_{m} + {λ}_{n} ) {z}_{mn} ( t ) {g}_{mn} ( t ) = - {\sum }_{m , n = {N}_{0} + 1}^{∞} ( \sqrt{{α}_{1}} ( {λ}_{m} + {λ}_{n} ) {z}_{mn} ( t ) ) ( \frac{1}{\sqrt{{α}_{1}}} {g}_{mn} ( t ) ) \leq - {α}_{1} \\ {\sum }_{m , n = {N}_{0} + 1}^{∞} {( {λ}_{m} + {λ}_{n} )}^{2} {z}_{mn}^{2} ( t ) - \frac{1}{{α}_{1}} {\vert {g}^{{N}_{0}^{2}} ( t ) \vert}^{2} + \frac{1}{{α}_{1}} {\sum }_{m , n = 1}^{∞} {g}_{mn}^{2} ( t ) .$$

$$where {α}_{1} > 0.$$

According to the boundary conditions of (1), we have

$${z}^{2} ( {x}_{1} , {x}_{2} , t ) \leq \frac{1}{2} [ {( {\int }_{0}^{{x}_{1}} \vert {z}_{{x}_{1}} ( s , {x}_{2} , t ) \vert ds )}^{2} + {( {\int }_{0}^{{x}_{2}} \vert {z}_{{x}_{2}} ( {x}_{1} , s , t ) \vert ds )}^{2} ] \leq \frac{1}{2} ( {‖ {z}_{{x}_{1}} ( {x}_{1} , {x}_{2} , t ) ‖}_{{L}^{2} ( Ω )}^{2} + {‖ {z}_{{x}_{2}} ( {x}_{1} , {x}_{2} , t ) ‖}_{{L}^{2} ( Ω )}^{2} ) \leq {σ}^{2} .$$

Using Parseval's equation, we obtain

$$\frac{1}{{α}_{1}} {\sum }_{m , n = 1}^{∞} {g}_{mn}^{2} ( t ) = \frac{1}{{α}_{1}} {\int }_{Ω} {z}_{{x}_{1}}^{2} ( {x}_{1} , {x}_{2} , t ) {z}^{2} ( {x}_{1} , {x}_{2} , t ) {dx}_{1} {dx}_{2} \leq \frac{{σ}^{2}}{{α}_{1}} {‖ {z}_{{x}_{1}} ‖}_{{L}^{2} ( Ω )}^{2} = \frac{{σ}^{2}}{{α}_{1}} {\vert {z}^{{N}_{0}^{2}} ( t ) \vert}_{Λ}^{2} + \frac{{σ}^{2}}{{α}_{1}} {\sum }_{m , n = {N}_{0} + 1}^{∞} {λ}_{m} {z}_{mn}^{2} ( t )$$

$$where Λ = diag {\{ {λ}_{m} \}}_{m = 1}^{{N}_{0}^{2}} .$$

$$Let η ( t ) = col \{ {z}^{{N}_{0}^{2}} ( t ) , {g}^{{N}_{0}^{2}} ( t ) \} .$$

### Then one has

$$V ( t ) + 2 δ V ( t ) \leq {η}^{T} ( t ) Ψη ( t ) + 2 {\sum }_{m , n = {N}_{0} + 1}^{∞} {{μ}_{mn} ( {λ}_{m} + {λ}_{n} )}^{2} {z}_{mn}^{2} ( t ) \leq 0.$$

$$where {μ}_{mn} {=}^{Δ} - ( {λ}_{m} + {λ}_{n} ) - κ + \frac{{λ}_{m} + δ}{( {λ}_{m} + {λ}_{n} )} + \frac{α}{2} + \frac{{α}_{1}}{2} + \frac{{λ}_{m} {σ}^{2}}{2 {{α}_{1} ( {λ}_{m} + {λ}_{n} )}^{2}} < 0 , m , n > {N}_{0}$$

$$and$$

$$Ψ {=}^{Δ} [ \begin{matrix}P ( {A}_{0} - {B}_{0} {K}_{0} ) + {( {A}_{0} - {B}_{0} {K}_{0} )}^{T} P + 2 δ P + ψ & - P \\ * & - \frac{1}{{α}_{1}}\end{matrix} ]$$

$$ψ {=}^{Δ} \frac{{σ}^{2}}{{α}_{1}} Λ + \frac{{‖ b ‖}_{{N}_{0}^{2}}^{2}}{α} {K}_{0}^{T} {K}_{0} .$$

From the monotonicity of λₘ, λₙ, m, n∈ [symbol] , we obtain that μₘₙ<0, m, n>N₀ holds if and only if μ_{N}_{₀}_{+1, N}_{₀}₊₁<0. By Schur complement lemma, μₘₙ<0 holds if and only if

$$[ \begin{matrix}- 2 {λ}_{{N}_{0} + 1} - κ + \frac{{λ}_{{N}_{0} + 1} + δ}{2 {λ}_{{N}_{0} + 1}} + \frac{α}{2} + \frac{{α}_{1}}{2} & 1 \\ * & - \frac{8 {α}_{1} {λ}_{{N}_{0} + 1}}{{λ}_{{N}_{0} + 1} {σ}^{2}}\end{matrix} ] < 0.$$

$$Denote Q = {P}^{- 1} , {Y}_{0} = {QK}_{0}^{T} .$$

Multiplying diag{P⁻¹, I} on the left and right sides of Ψ together by Schur complement lemma, we obtain that Ψ<0 holds if and only if

$$[ \begin{matrix}{A}_{0} Q + {QA}_{0}^{T} - {Y}_{0} {B}_{0} - {B}_{0} {Y}_{0}^{T} + 2 δ Q + {α}_{1} I & {Y}_{0} & Q {Λ}^{\frac{1}{2}} \\ * & - α {‖ b ‖}_{{N}_{0}^{2}}^{- 2} I & 0 \\ * & * & - \frac{{α}_{1}}{{σ}^{2}} I\end{matrix} ] < 0.$$

Next, we show that if the initial condition satisfies

$${‖ {z}_{{x}_{1}} ( \cdot , 0 ) ‖}_{{L}^{2} ( Ω )}^{2} + {‖ {z}_{{x}_{2}} ( \cdot , 0 ) ‖}_{{L}^{2} ( Ω )}^{2} < 2 {ρ}^{2} , ρ = σ \sqrt{\frac{min ( {σ}_{min} ( {P}^{*} ) , 1 )}{max ( {σ}_{max} ( {P}^{*} ) , 1 )}}$$

$$where {P}^{*} = {Λ}_{1}^{- \frac{1}{2}} P {Λ}_{1}^{- \frac{1}{2}} , {Λ}_{1} = diag {\{ {λ}_{m} + {λ}_{n} \}}_{m , n = 1}^{{N}_{0}^{2}} ,$$

then the following inequality holds:

$${‖ {z}_{{x}_{1}} ( \cdot , t ) ‖}_{{L}^{2} ( Ω )}^{2} + {‖ {z}_{{x}_{2}} ( \cdot , t ) ‖}_{{L}^{2} ( Ω )}^{2} \leq 2 {σ}^{2} , ∀ t > 0.$$

Suppose that there exists

$${t}_{1} > 0 satisfying {‖ {z}_{{x}_{1}} ( \cdot , {t}_{1} ) ‖}_{{L}^{2} ( Ω )}^{2} + {‖ {z}_{{x}_{2}} ( \cdot , {t}_{1} ) ‖}_{{L}^{2} ( Ω )}^{2} ⩾ 2 {σ}^{2} ,$$

$$while {‖ {z}_{{x}_{1}} ( \cdot , 0 ) ‖}_{{L}^{2} ( Ω )}^{2} + {‖ {z}_{{x}_{2}} ( \cdot , 0 ) ‖}_{{L}^{2} ( Ω )}^{2} < 2 {ρ}^{2} ⩽ 2 {σ}^{2} .$$

By the continuity of the function zₓ_{₁}(⋅, t) and zₓ_{₂}(⋅, t), there exists t*∈(0, t₁] such that

$${‖ {z}_{{x}_{1}} ( \cdot , t ) ‖}_{{L}^{2} ( Ω )}^{2} + {‖ {z}_{{x}_{2}} ( \cdot , t ) ‖}_{{L}^{2} ( Ω )}^{2} < 2 {σ}^{2} , ∀ t ∈ [ 0 , {t}^{*} ) and {‖ {z}_{{x}_{1}} ( \cdot , {t}^{*} ) ‖}_{{L}^{2} ( Ω )}^{2} + {‖ {z}_{{x}_{2}} ( \cdot , {t}^{*} ) ‖}_{{L}^{2} ( Ω )}^{2} = 2 {σ}^{2} .$$

According to comparison principle, we obtain that V(t)≤e^{-2δt}V(0), t∈[0, t*) and

$$V ( t ) \geq min ( {σ}_{min} ( {P}^{*} ) , 1 ) ( {‖ {z}_{{x}_{1}} ( \cdot , t ) ‖}_{{L}^{2} ( Ω )}^{2} + {‖ {z}_{{x}_{2}} ( \cdot , t ) ‖}_{{L}^{2} ( Ω )}^{2} ) ,$$

$$V ( t ) \leq max ( {σ}_{max} ( {P}^{*} ) , 1 ) ( {‖ {z}_{{x}_{1}} ( \cdot , t ) ‖}_{{L}^{2} ( Ω )}^{2} + {‖ {z}_{{x}_{2}} ( \cdot , t ) ‖}_{{L}^{2} ( Ω )}^{2} ) .$$

Then we have

$${‖ {z}_{{x}_{1}} ( \cdot , t ) ‖}_{{L}^{2} ( Ω )}^{2} + {‖ {z}_{{x}_{2}} ( \cdot , t ) ‖}_{{L}^{2} ( Ω )}^{2} \leq {‖ {z}_{{x}_{1}} ( \cdot , 0 ) ‖}_{{L}^{2} ( Ω )}^{2} + {‖ {z}_{{x}_{2}} ( \cdot , 0 ) ‖}_{{L}^{2} ( Ω )}^{2} < 2 {e}^{- 2 δ t} {σ}^{2} , t ∈ [ 0 , {t}^{*} ) .$$

$$Contradiction with {‖ {z}_{{x}_{1}} ( \cdot , {t}^{*} ) ‖}_{{L}^{2} ( Ω )}^{2} + {‖ {z}_{{x}_{2}} ( \cdot , {t}^{*} ) ‖}_{{L}^{2} ( Ω )}^{2} = 2 {σ}^{2} , therefore V ( t ) \leq {e}^{- 2 δ t} V ( 0 ) , t ∈ [ 0 , ∞ ) .$$

V(t) is equivalent to the H¹(Ω) norm of z(x, t). Thus,

$${‖ z ( \cdot , t ) ‖}_{{H}^{1} ( Ω )}^{2} \leq {M}_{0} {e}^{- 2 δ t} {‖ z ( \cdot , 0 ) ‖}_{{H}^{1} ( Ω )}^{2} , t ∈ [ 0 , ∞ ) where {M}_{0} \geq 1.$$

### 4: Designing H_{∞} Finite-Dimensional Controller in the Presence of an External Disturbance;

Consider the two-dimensional Kuramoto-Sivashinsky equation on Ω=[0,1]×[0,1]:

$$\{ \begin{matrix}{z}_{t} + {zz}_{{x}_{1}} + ( 1 - κ ) {z}_{{x}_{1} {x}_{1}} - κ {z}_{{x}_{2} {x}_{2}} + {Δ}^{2} z = b ( x ) u ( t ) + ω ( x , t ) , z {\vert}_{\partial Ω} = 0 , \\ \frac{\partial z}{\partial n} {\vert}_{\partial Ω} = 0.\end{matrix} \qquad ( 3 )$$

where ω(x, t) is an external disturbance and z(x, t₀)=0, the remaining parameters and variables are the same as in (1).

Projecting the system state onto the eigenspace of the two-dimensional Sturm-Liouvile operator yields, we have

$${\dot{z}}_{mn} ( t ) = [ - {( {λ}_{m} + {λ}_{n} )}^{2} - κ ( {λ}_{m} + {λ}_{n} ) + {λ}_{m} ] {z}_{mn} ( t ) + {b}_{mn} u ( t ) - {g}_{mn} ( t ) + {ω}_{mn} ( t ) where {ω}_{mn} ( t ) = 〈 ω , {ϕ}_{mn} 〉 .$$

Designing a finite-dimensional controller of the following form:

$$u ( t ) = - {K}_{0} {z}^{{N}_{0}^{2}} ( t ) , {z}^{{N}_{0}^{2}} = {[ {z}_{11} , … , {z}_{{N}_{0} {N}_{0}} ]}^{T}$$

where K₀ is the controller gain.

$$Let {ω}^{{N}_{0}^{2}} ( t ) = col \{ {ω}_{11} ( t ) , … , {ω}_{{N}_{0} {N}_{0}} ( t ) \} .$$

The closed-loop system can be presented as

$${\dot{z}}^{{N}_{0}^{2}} ( t ) = ( {A}_{0} - {B}_{0} {K}_{0} ) {z}^{{N}_{0}^{2}} ( t ) - {g}^{{z}^{{N}_{0}^{2}}} ( t ) + {ω}^{{z}^{{N}_{0}^{2}}} ( t ) , {z}_{mn} ( t ) = [ - {( {λ}_{m} + {λ}_{n} )}^{2} - κ ( {λ}_{m} + {λ}_{n} ) + {λ}_{m} ] {z}_{mn} ( t ) - {b}_{mn} {K}_{0} {z}^{{N}_{0}^{2}} ( t ) - {g}_{mn} ( t ) + {ω}_{mn} , m , n > {N}_{0} \qquad ( 4 )$$

Next, we consider the H_{∞} control design for the system.

Given the parameter γ>0, consider the performance index

$$J = {\int }_{0}^{∞} {\int }_{Ω} ( {z}^{2} - {γ}^{2} {ω}^{2} ) dxdt .$$

Note that if \dot{V}+2δV+∫_{Ω}(z²−γ²ω²)dx<0, integrating it with respect to t yields J<0. Differentiating V(t) along the closed-loop system (4) leads to

$$\dot{V} + 2 δ V + {\int }_{Ω} ( {z}^{2} - {γ}^{2} {ω}^{2} ) dx = \dot{V} + 2 δ V + {\int }_{Ω} [ {( {\sum }_{m , n = 1}^{∞} {z}_{mn} ( t ) {ϕ}_{mn} ( x ) )}^{2} - {{γ}^{2} ( {\sum }_{m , n = 1}^{∞} {ω}_{mn} ( t ) {ϕ}_{mn} ( x ) )}^{2} ] dx = \dot{V} + 2 δ V + {\sum }_{m , n = 1}^{∞} {z}_{mn}^{2} ( t ) - {γ}^{2} {\sum }_{m , n = 1}^{∞} {ω}_{mn}^{2} ( t ) \leq \dot{V} + 2 δ V + {( {z}^{{N}_{0}^{2}} ( t ) )}^{T} {z}^{{N}_{0}^{2}} ( t ) + {\sum }_{m , n = {N}_{0} + 1}^{∞} {z}_{mn}^{2} ( t ) - {{γ}^{2} ( {ω}^{{N}_{0}^{2}} ( t ) )}^{T} {ω}^{{N}_{0}^{2}} ( t ) .$$

$$Let η ( t ) = col \{ {z}^{{N}_{0}^{2}} ( t ) , {g}^{{N}_{0}^{2}} ( t ) , {ω}^{{N}_{0}^{2}} ( t ) \} .$$

Based on the proof of step 3, we have the following result:

If there exists

$$0 < Q ∈ {ℝ}^{{N}_{0}^{2} \times {N}_{0}^{2}} , {Y}_{0} ∈ {ℝ}^{{N}_{0}^{2} \times M} and scalar α > 0 , {α}_{1} > 0$$

satisfying the following linear matrix inequalities:

$${Ψ}_{1} < 0 , {Ψ}_{2} < 0$$

$$where$$

$${Ψ}_{1} = [ \begin{matrix}- 8 {λ}_{{N}_{0} + 1}^{3} + 2 ( α + {α}_{1} - 2 κ ) {λ}_{{N}_{0} + 1}^{2} + 2 ( {λ}_{{N}_{0} + 1} + δ ) {λ}_{{N}_{0} + 1} + \frac{1}{2} & 1 \\ * & - \frac{2 {α}_{1}}{{λ}_{{N}_{0} + 1} {σ}^{2}}\end{matrix} ] ,$$

$${Ψ}_{2} = [ \begin{matrix}{A}_{0} Q + {QA}_{0}^{T} - {B}_{0} {Y}_{0}^{T} - {Y}_{0} {B}_{0}^{T} + 2 δ Q + {α}_{1} I & {Y}_{0} & {QA}^{\frac{1}{2}} & YQ \\ * & - α {‖ b ‖}_{{N}_{0}^{2}}^{- 2} I & 0 & 0 \\ * & * & - \frac{{α}_{1}}{{σ}^{2}} I & 0 \\ * & * & * & - {γ}^{2} I\end{matrix} ] ,$$

then the closed-loop system (4) achieves the H_{∞} performance meaning that the closed-loop system (4) has the L₂-gain less than γ.

### The Following is a Verification of the Effectiveness of H_{∞} Finite-Dimensional Controller Proposed in the Present Invention.

Set M=N₀=1, δ=0.01, σ=1, κ=−20. The linear matrix inequality conditions in step 3 is verified by Yamlip. The feasible solutions are given as

$$α = 71.933 , {α}_{1} = 11.572 , Q = 0.676 , {Y}_{0} = 50.412 , ρ = 0.274 , {K}_{0} = {Y}_{0}^{T} {Q}^{- 1} = 74.575 .$$

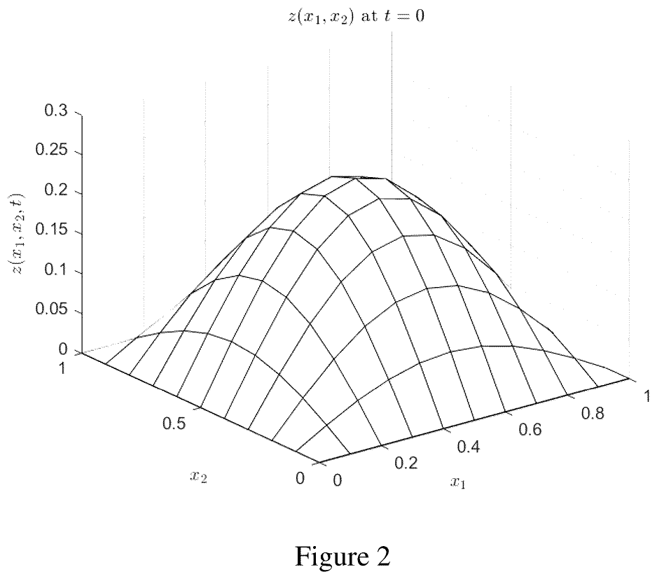

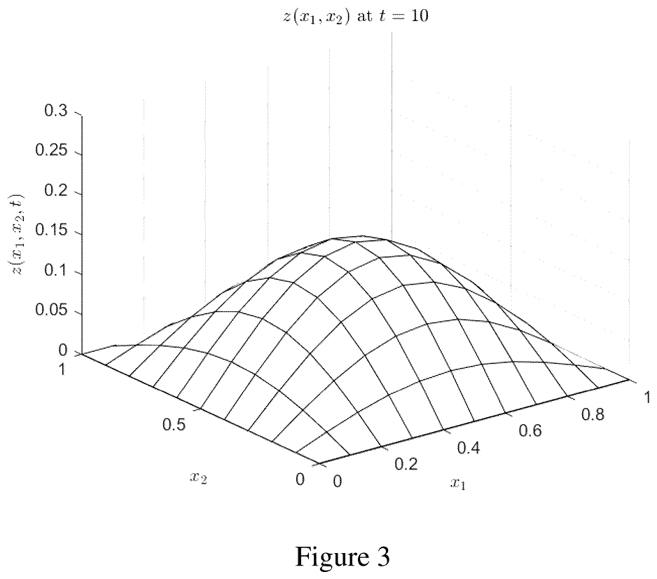

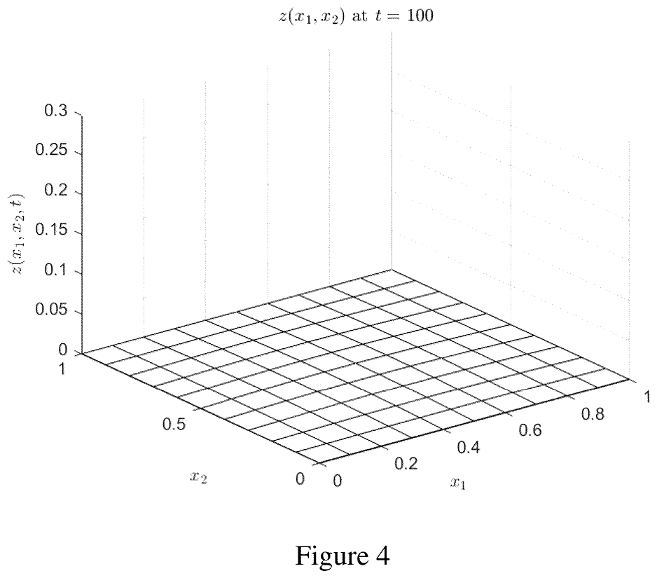

FIG. 2, FIG. 3, and FIG. 4 depict the state of the closed-loop system (2) at different times t∈{0, 10, 100} with the parameter

$${K}_{0} = {Y}_{0}^{T} {Q}^{- 1} = 74.575$$

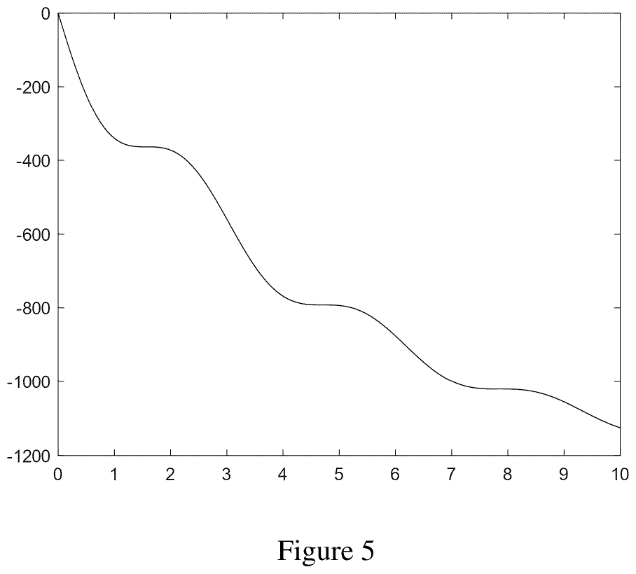

and the initial condition z(x₁, x₂, 0)=0.236 sin(πx₁) sin(πx₂), (x₁, x₂)∈Ω. FIG. 5 depicts the performance index J over time with the parameter γ=10 and the disturbance ω(x, t)=(1+x₁+x₂)cos t·e^{-0.1t}. The simulation results show that the closed-loop system exhibits internal exponential stability and has a performance index of J<0, indicating that the proposed H_{∞} finite-dimensional controller is effective and robust against external disturbances.

1. A H_{∞} finite-dimensional control design method for two-phase annular flow based on modal decomposition, comprising: establishing a model of two-phase annular flow based on the two-dimensional Kuramoto-Sivashinsky equation; designing a finite-dimensional controller to stabilize two-phase annular flow system based on the current state; establishing the closed-loop system and deriving the sufficient conditions for the regional stability of the closed-loop system via the direct Lyapunov method; designing H_{∞} finite-dimensional controller in the presence of an external disturbance.

2. The method as in claim 1, wherein the method is characterized by modelling the two-phase annular flow based on the two-dimensional Kuramoto-Sivashinsky equation
$${z}_{t} + {zz}_{{x}_{1}} + ( 1 - κ ) {z}_{{x}_{1} {x}_{1}} - κ {z}_{{x}_{2} {x}_{2}} + {Δ}^{2} z = b ( x ) u ( t )$$
with the Dirichlet boundary conditions
$$Z {\vert}_{\partial Ω} = 0 , \frac{\partial z}{\partial n} {\vert}_{\partial Ω} = 0 ;$$
model parameters include bounded area Ω=[0,1]×[0,1] and angle of substrate with respect to the horizontal κ; model variables include position variable x=(x₁, x₂)∈Ω, time variable t>0, z∈ [symbol] denotes the thin film thickness, control input u(t)=col[u₁(t), . . . , u_{M}(t)], characteristic functions
$$b ( x ) = [ {b}_{1} ( x ) , ⋯ , {b}_{M} ( x ) ] ∈ {ℝ}^{1 \times M} , {b}_{i} ( x ) = \{ \begin{matrix}1 , & x ∈ Ω , \\ 0 , & x ∉ Ω .\end{matrix}$$

3. The method as in claim 1, wherein the method is characterized by the eigenvalues and eigenfunctions of the two-dimensional Sturm-Liouvile operator
$${λ}_{m} + {λ}_{n} = ( {m}^{2} + {n}^{2} ) {π}^{2} ,$$
$${ϕ}_{mn} ( x ) = 2 sin ( \sqrt{{λ}_{m}} {x}_{1} ) sin ( \sqrt{{λ}_{n}} {x}_{2} ) , m , n = 1 , 2 …$$
projecting the two-dimensional Kuramoto-Sivashinsky equation onto the eigenspace of the Sturm-Liouvile operator yields
$${\dot{z}}_{mn} ( t ) = [ - {( {λ}_{m} + {λ}_{n} )}^{2} - κ ( {λ}_{m} + {λ}_{n} ) + {λ}_{m} ] {z}_{mn} ( t ) + {b}_{mn} u ( t ) - {g}_{mn} ( t ) ,$$
$$where$$
$${z}_{mn} ( 0 ) = 〈 z ( \cdot , 0 ) , {ϕ}_{mn} 〉 , {b}_{mn} = [ 〈 {b}_{1} , {ϕ}_{mn} 〉 , ⋯ , 〈 {b}_{M} , {ϕ}_{mn} 〉 ] , {g}_{mn} ( t ) = 〈 {zz}_{{x}_{1}} , {ϕ}_{mn} 〉 .$$

4. The method as in claim 1, wherein the method is characterized by the first finite-dimensional controller:
$$u ( t ) = - {K}_{0} {z}^{{N}_{0}^{2}} ( t ) , {z}^{{N}_{0}^{2}} = {[ {z}_{11} , … , {z}_{{N}_{0} {N}_{0}} ]}^{T} ,$$
where K₀ is the controller gain.

5. The method as in claim 4, wherein the method is characterized in that the closed-loop system is built according to the first finite-dimensional controller;
according to the Lyapunov method, using the Lyapunov function
$$V ( t ) = {\vert {z}^{{N}_{0}^{2}} ( t ) \vert}_{P}^{2} + {\sum }_{m , n = {N}_{0} + 1}^{∞} ( {λ}_{m} + {λ}_{n} ) {z}_{mn}^{2} ( t )$$
to derive the linear matrix inequality conditions that ensure regional stability of the closed-loop system.

6. The method as in claim 1, wherein the method is characterized in that two-phase annular flow H_{∞} control problem is established using the following two-dimensional Kuramoto-Sivashinsky equation with perturbations:
$${z}_{t} + {zz}_{{x}_{1}} + ( 1 - κ ) {z}_{{x}_{1} {x}_{1}} + {Δ}^{2} z = ω ( x , t ) + b ( x ) u ( t ) ,$$
with the Dirichlet boundary conditions
$$Z {\vert}_{\partial Ω} = 0 , \frac{\partial z}{\partial n} {\vert}_{\partial Ω} = 0 and z ( x , {t}_{0} ) = 0 ,$$
where ω(x, t) denotes disturbance in engineering practice;
using the formula
$$u ( t ) = - {K}_{0} {z}^{{N}_{0}^{2}} ( t ) , {z}^{{N}_{0}^{2}} = {[ {z}_{11} , … , {z}_{{N}_{0} {N}_{0}} ]}^{T} ;$$
the second finite-dimensional controller is established, where K₀ is the controller gain.

7. The method as in claim 1, wherein the method is characterized by the H_{∞} finite-dimensional controller design for the two-phase annular flow system; the performance index is given by
$$J = {\int }_{0}^{∞} {\int }_{Ω} ( {z}^{2} - {γ}^{2} {ω}^{2} ) dxdt$$
with the constant γ>0; the closed-loop system is internally stable and the H_{∞} performance is guaranteed.
